(19) United States
(12) Patent Application Publication
(10) Pub. No.: US 2009/0239577 A1
(43) Pub. Date: Sep. 24, 2009

(54) Method and system for multimedia captures with remote triggering

(75) Inventors: Michael Holton, Manhattan Beach, CA (US); Clifford Wong, Burbank, CA (US); Jonathan M. Ackley, Glendale, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISE, INC., BURBANK, CA (US)

(21) Appl. No.: 12/077,893

(22) Filed: Mar. 21, 2008

(51) Int. Cl. H04M 1/00

(52) U.S. Cl. 455/556.1

(57) ABSTRACT

There is provided a system for triggering a multimedia unit to capture multimedia. The system comprises a multimedia unit configured to capture multimedia, which may be images, video, or other sensory information. The system may further comprise a wireless device, such as a cell phone, configured to send a triggering signal, such as an SMS message, wherein the triggering signal includes an identifier for the wireless device. The system may further comprise a wireless network, such as a cellular network, configured to carry the triggering signal and configured to carry the multimedia. The system may further comprise a multimedia host configured to receive the multimedia via a system network and to present the multimedia to a user of the system for capturing multimedia via a built-in multimedia display or to a client computer via the Internet.

### BACKGROUND OF THE INVENTION

1. Field of the Invention

The present invention relates generally to multimedia communications. More particularly, the present invention relates to multimedia captures and processing.

2. Background Art

Today, cameras for capturing multimedia such as pictures and videos are widely incorporated in cellular phones and other portable devices. A person may employ several conventional techniques to appear in a video or image created with his own camera. In one crude technique, the person may hold out the camera at arm's length, with the camera pointed back toward himself. In this way, the person can capture, for example, a picture of himself and a feature in the place of interest. This technique, while simple, has clear disadvantages. For example, it is difficult for the person to estimate what the camera is pointed at, and it is also difficult for the person to hold the camera steady, and to ensure that the camera is properly focused. Additionally, the resulting picture has limited viewing area because of the length of the person's arm, and is likely to only capture the person's facial expression.

Another conventional technique that allows a person to appear in multimedia created with his own camera is the use of a tripod or similar positioning device. By using a tripod, for example, better pictures can be created than by the first technique. However, there are still several disadvantages. First, the person must carry a cumbersome, compatible tripod. Second, after positioning his camera, the person must move away from the camera to be visible in the picture, thereby exposing the camera to potential damage or theft. Third, the camera can only be positioned in vantage points accessible to the person, when harder-to-reach vantage points might provide better pictures. Finally, positioning the camera in a suitable, accessible vantage point may be an exhausting process.

Several other conventional techniques allow a person to appear in multimedia with a feature at the place of interest without using his own camera. In these techniques, for example, a camera may be pre-positioned at the place of interest and oriented to face a feature there. The person may trigger a countdown, move to the feature, and wait for the pre-positioned camera to capture a picture. Techniques for triggering the countdown include pressing a button on the pre-positioned camera, or presenting an infrared fob to the pre-positioned camera. These techniques have several advantages over those previously mentioned. A person does not need to own a camera or a tripod, and cameras can be pre-positioned in places that a person might not be able to access. However, systems employing these techniques have disadvantages involving high costs involved with providing and managing infrared fobs, and disadvantages in distributing the resulting multimedia to system users. In addition, these techniques are not very intuitive or interactive, and require careful and thoughtful training of the person to properly use and maintain the provided infrared fob with the pre-positioned camera.

Accordingly, there is a need to overcome the drawbacks and deficiencies in the art by providing an improved method or system for multimedia captures with remote triggering.

### SUMMARY OF THE INVENTION

There are provided methods and systems for multimedia captures with remote triggering, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for multimedia captures with remote triggering, according to one embodiment of the present invention; and

FIG. 2 is a flowchart presenting a method for multimedia captures with remote triggering, according to one embodiment of the present invention.

### DETAILED DESCRIPTION OF THE INVENTION

The present application is directed to a method and system for multimedia captures with remote triggering. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

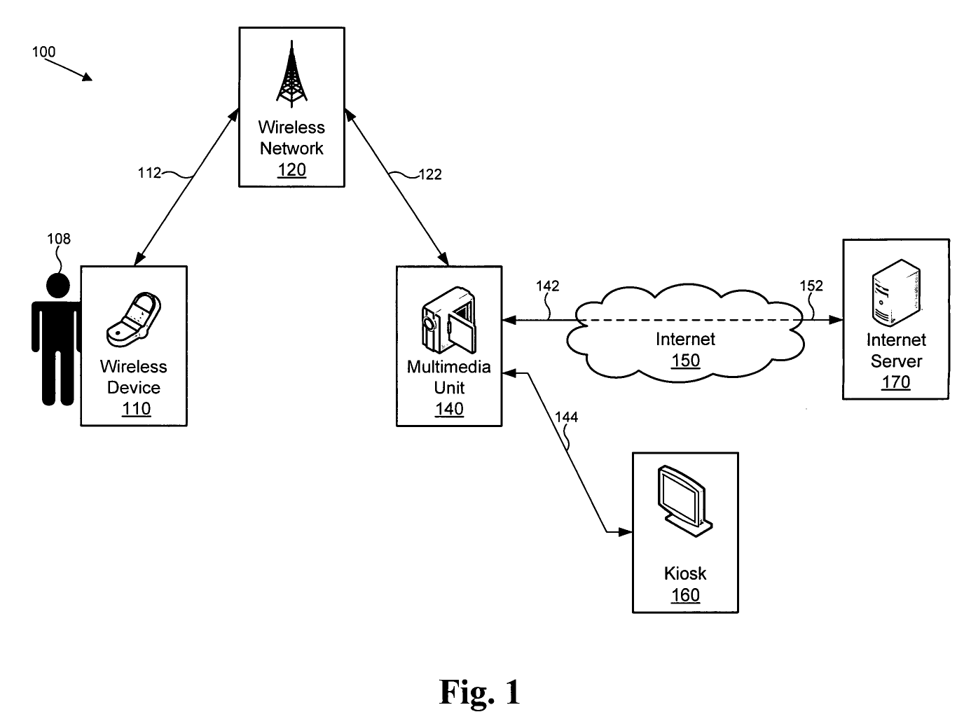

FIG. 1 shows a system 100 for multimedia captures with remote triggering, according to one embodiment of the present invention. System 100 includes wireless device 110, wireless network 120, and multimedia unit 140. Wireless device 110 and multimedia unit 140 communicate through wireless network 120, which in this embodiment is a cellular network, via links 112 and 122. System 100 additionally includes Internet 150, kiosk 160, and Internet server 170. Multimedia unit 140 communicates with kiosk 160 via link 144 and Internet server 170 through Internet 150 via links 142 and 152.

Wireless device 110, multimedia unit 140, and kiosk 160 are, in this embodiment, located in a theme park. Other embodiments of the invention might situate wireless device 110, multimedia unit 140, and kiosk 160 at a different public or private venue, for example, a shopping mall, a movie theater lobby, a restaurant front, a sporting event, a music concert, or a vacation spot. In this embodiment, multimedia unit 140 and kiosk 160 are permanently installed at fixed locations in the park, but in other embodiments multimedia unit 140 and kiosk 160 may be, for example, portable devices that can be deployed and removed at temporary locations.

Wireless device 110 moves around the park in the possession of person 108, a guest of the park and a user of the system for capturing multimedia. Wireless network 120, which is in this embodiment a cellular network, may be composed of multiple cell towers and cellular infrastructure components that exist both inside and outside of the park. In this embodiment, wireless network 120 is part of a communication infrastructure that is not controlled by the park owner, but in other embodiments of the invention some part or all of wireless network 120 is controlled by the park owner. Internet 150 and Internet server 170 are, in this embodiment, situated outside the park.

Wireless device 110 can be a cell phone, a PDA, or any other portable device capable of communication with wireless network 120 over link 112, which in this embodiment is a bidirectional radio-frequency link using a synchronous or asynchronous messaging protocol.

Wireless device 110 in this embodiment comprises multiple elements, including a transmitter configured to transmit a triggering signal on link 112 and a receiver configured to receive MMS and SMS messages on link 112. Wireless device 110 additionally comprises an input device, such as a keypad, configured for inputting the triggering signal by person 108 and a display configured to acknowledge received messages to person 108. Finally, wireless device 110 also comprises a memory configured to store user inputs and received messages, as well as a processor configured to execute software for various wireless device 110 functions.

Wireless device 110 can send and receive Short Message Service (SMS) messages, and may additionally be configured to make ordinary phone calls, to receive Multimedia Messaging Service (MMS) messages, or to engage in Wireless Application Protocol (WAP) and Hyper Text Transport Protocol (HTTP) sessions. Wireless device 110 can be additionally configured to establish Bluetooth or Zigbee connections directly to compatible devices, or to communicate directly with compatible devices using NFC (Near Field Communication) or UWB (Ultra Wide Band) local wireless techniques, without using link 112. In some embodiments, wireless device 110 may also be configured to utilize WiFi, WiMax, GPRS, and EDGE connections. In this embodiment, wireless device 110 is a cell phone in the possession of person 108.

As person 108 moves around the park with wireless device 110, person 108 may enter a zone visible to multimedia unit 140. In this embodiment, multimedia unit 140 comprises a video camera configured to record videos from which pictures can be extracted. Multimedia unit 140 additionally comprises an LCD screen for displaying identification information, instructions, and countdown information. In other embodiments, multimedia unit 140 can be a camera capable of capturing other types of multimedia, such as still images or audio-visual recordings, and the LCD screen may be a different type of display. Multimedia unit 140 has been pre-positioned to record video of a zone in the park with particular aesthetic qualities, for example, a pleasing landscape. Upon entering the pleasing landscape, person 108 may learn about multimedia unit 140 by reading the LCD screen, and may activate multimedia unit 140 by sending a triggering signal from wireless device 110.

Wireless device 110 can be utilized to activate multimedia unit 140 by, for example, transmitting a triggering signal in the form of an SMS message to multimedia unit 140. Multimedia unit 140 can be implemented so that an SMS short code is displayed on the LCD screen. The SMS short code is a shortened, special-purpose telephone number that is unique to multimedia unit 140. Person 108 can read the SMS short code and any associated instructions on the LCD screen, and then address and send an SMS message to the SMS short code. The SMS message is routed by wireless network 120 to arrive at multimedia unit 140. In other embodiments of the invention, person 108 can send a triggering signal by using wireless device 110 to make a phone call to multimedia unit 140 via wireless network 120, by using wireless device 110 to make a Bluetooth connection directly to multimedia unit 140, or by utilizing another wireless connection capability of wireless device 110.

Multimedia unit 140 is configured to communicate with wireless network 120 over link 122, with Internet 150 over link 142, and with kiosk 160 over link 144. In this embodiment, links 122, 142, and 144 are physical lines, but in another embodiment one or more of links 122, 142, and 144 may be wireless. Upon receiving an SMS message triggering signal over link 122, multimedia unit 140 initiates a countdown timer, and displays the countdown timer and an identifier, which is a user identification number, on the LCD screen. The countdown timer has a starting value sufficiently high so that person 108, observing the countdown on the LCD screen of multimedia unit 140, has adequate time to pose, e.g. ten seconds. The user identification number uniquely identifies wireless device 110, is derived from the sending phone number of wireless device 110, and is necessary, for example, in case a second person (not shown) has SMS messaged multimedia unit 140 using a second wireless device. In that case, multimedia unit 140 will receive two triggering signals, and must display a unique user identification number so that person 108 can prepare for video to be taken, and the second person can avoid interfering.

Multimedia unit 140 may start recording video before the countdown has finished, and may continue recording after the countdown has finished. For example, multimedia unit 140 might countdown for ten seconds, begin recording two seconds before the countdown zero point, and continue recording for two seconds after the zero point. By recording around the zero point in this fashion, multimedia unit 140 captures additional video that person 108 might enjoy more than that video captured precisely at the zero point. For example, if person 108 blinks at the zero point, person 108 might enjoy more an image from the video captured one second sooner or later. In another embodiment of the invention, rather than recording during a four second window around the zero point, multimedia unit 140 may start recording after recognizing a visual trigger during the countdown, such as a hand gesture or other motion by person 108. From the four-second video recorded, a sequence of pictures can subsequently be extracted.

Multimedia unit 140, having finished recording, proceeds to extract pictures from the video. Multimedia unit 140 can extract a sample picture from the video that is small enough to be sent in an MMS message to wireless device 110. The MMS message containing the sample picture is transmitted to wireless device 110, on which the sample picture can be reviewed by person 108, over wireless network 120 via links 122 and 112. Additionally, person 108 can be informed by the MMS message that additional multimedia can be viewed at a multimedia host, such as, in this embodiment, kiosk 160 or Internet server 170.

If wireless device 110 is not configured to receive MMS messages, then multimedia unit 140 will send wireless device 110 an SMS message instead. The SMS message will contain a WAP link to multimedia unit 140, and multimedia unit 140 will host the extracted sample picture on a WAP site viewable to a WAP browser during a WAP session. Upon receiving the SMS message, person 108 can instruct wireless device 110 to view the WAP site and download the sample picture in that manner. The SMS message, like the MMS message, can also inform person 108 that additional multimedia can be viewed at kiosk 160 or Internet server 170.

After sending either an MMS or SMS message to wireless device 110, multimedia unit 140 can extract high-quality pictures from the video taken by multimedia unit 140 to send to kiosk 160 via system network link 144, which is in this embodiment a direct link. The extracted high-quality pictures, in this embodiment, can be photorealistic. Kiosk 160, located in the park, has a built-in multimedia display, such as an LCD screen, suitable for displaying instructions and multimedia. When person 108 arrives at kiosk 160, person 108 can view the high-quality pictures by entering a unique user identification number, such as the cell phone number of wireless device 110 or an identifier transmitted in the MMS or SMS message. Kiosk 108 is configured to allow person 108 to select one or more high-quality pictures, print out hard copies of the selected pictures, and accept payment.

In addition to sending high-quality pictures to kiosk 160, multimedia unit 140 can send the high-quality pictures to Internet server 170 through Internet 150 via system network links 142 and 152. The MMS or SMS message sent to wireless device 110 by multimedia unit 140 provides instructions for downloading the high-quality pictures on Internet server 170. Person 108 can leave the park, follow the instructions, and access Internet server 170 from, for example, a client computer such as a home computer (not shown) connected to Internet 150. Internet server 170 is configured to allow the selection and downloading of the high-quality pictures to the home computer of person 108, after payment of a fee.

While in this embodiment of the invention multimedia unit 140 extracts a sample picture from the video and transmits the sample picture to wireless device 110, in an alternative embodiment kiosk 108 or Internet server 170 can perform these tasks. In the alternative embodiment, after multimedia unit 140 sends high-quality pictures to kiosk 108 or Internet server 170, kiosk 108 or Internet server 170 can extract a sample picture from the high-quality pictures and transmit the sample picture in, for example, an MMS message to wireless device 110 via wireless network 120. In such an alternative embodiment, the complexity of multimedia unit 140 is reduced.

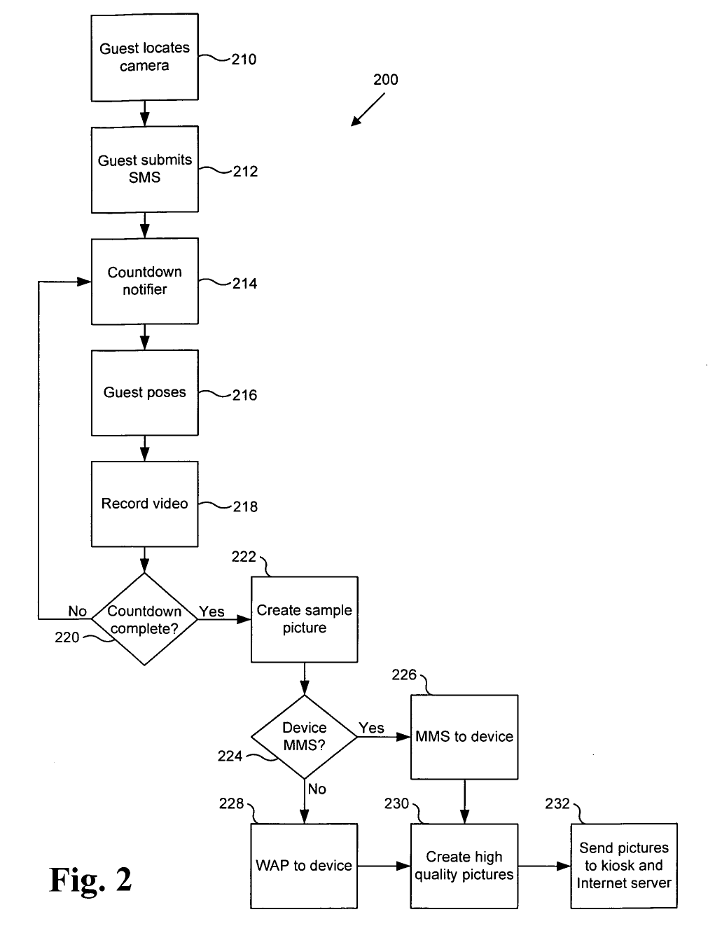

FIG. 2 shows flowchart 200 of an exemplary method for multimedia captures with remote triggering, according to one embodiment of the present invention. Certain details and features have been left out of flowchart 200 that are apparent to a person of ordinary skill in the art. For example, a step may comprise one or more substeps or may involve specialized equipment or materials, as known in the art. While steps 210 through 232 indicated in flowchart 200 are sufficient to describe one embodiment of the present invention, other embodiments of the invention may utilize steps different from those shown in flowchart 200.

In step 210 of flowchart 200, a theme park guest corresponding to person 108 of FIG. 1 locates a multimedia unit corresponding to multimedia unit 140. In this embodiment, the multimedia unit comprises a video camera configured to record videos from which pictures can be extracted, and an LCD screen or electronic display for displaying identification information, instructions, and countdown information. Additionally, the multimedia unit has been pre-positioned to record video of a zone in the park with particular aesthetic qualities, for example, a pleasing landscape. After locating the multimedia unit, the guest interacts with the multimedia unit as described in step 212.

In step 212 of flowchart 200, the guest interacts with the multimedia unit by transmitting a triggering signal in the form of a Short Message Service (SMS) message. After reading instructions on the multimedia unit LCD screen that include, for example, an SMS short code, the guest sends the SMS by utilizing a wireless device corresponding to wireless device 110 in FIG. 1. The wireless device may be, for example, a cellular phone, a portable music device, a portable multimedia device, or a PDA. The SMS message is routed by, for example, a cellular network corresponding to wireless network 120 to arrive at the multimedia unit, which then initiates a countdown timer.

Steps 214, 216, 218, and 220 of flowchart 200 together comprise a repeatable loop. In step 214, a multimedia unit countdown timer has started counting down, and a countdown notifier is displayed on the multimedia unit LCD screen for the guest to observe. In step 216, the guest poses by moving to a position visible to the multimedia unit. The position might be marked, for example, by a symbol painted on the ground indicating where the guest should stand. In step 218, the multimedia unit captures video of the guest, from which still pictures can subsequently be extracted. In step 220, if the countdown is not complete, flowchart 200 returns to step 214, and repeats the steps for countdown notification, guest posing, and video capture. However, if the countdown is complete, flowchart 200 proceeds to step 222.

In step 222 of flowchart 200, the countdown has finished, and the multimedia unit has recorded a video of the guest from which pictures will be extracted. The multimedia unit may continue recording for a short period of time after the countdown finishes, so that additional pictures can be prepared for the guest. After recording stops, the multimedia unit extracts a sample picture from the video. The sample picture can be displayed to the guest on the wireless device so that the guest can have visual feedback from the recording session.

In step 224 of flowchart 200, the multimedia unit chooses a means for sending the sample picture to the wireless device. If the wireless device is capable of receiving Multimedia Messaging Service (MMS) messages, the multimedia unit can send the sample picture in an MMS message to the wireless device in step 226. Upon receiving the MMS message, the guest can view the sample picture on the wireless device. Alternatively, if the wireless device is not capable of receiving MMS messages, in step 228 the multimedia unit can instead host the sample picture on a WAP site, and send the wireless device an SMS message containing a WAP link to the sample picture. The guest can then view the sample picture on the wireless device by utilizing a WAP browser. After either step 226 or 228, flowchart 200 proceeds to step 230.

In step 230 of flowchart 200, the multimedia unit has made the sample picture available to the guest, and proceeds to extract high-quality pictures from the video. If the multimedia unit captured a four-second video, then the multimedia unit might, for example, extract five images that are evenly spaced out across the video time span. In this fashion, the multimedia unit creates more than one high-quality picture from each camera session. By doing so, the multimedia unit can present multiple pictures to the guest, so that if one of the pictures is aesthetically displeasing, the guest can choose a different one from the same session.

In step 232 of flowchart 200, the multimedia unit transmits the high-quality pictures to a multimedia host kiosk corresponding to kiosk 160 over a system network link corresponding to link 144 in FIG. 1, and to a multimedia host corresponding to Internet server 170 over system network links corresponding to links 142 and 152 in FIG. 1. If the guest would like to view the high-quality pictures, the guest can go to the kiosk and access the high-quality pictures by entering a unique identifier, which may be, for example, the phone number of the wireless device. The guest also has the option of viewing the high-quality pictures on the Internet server by accessing the Internet server over the Internet by using, for example, a home computer. When viewing the high-quality pictures on the kiosk or the Internet server, the guest may select one or more high-quality pictures to print out or to download, respectively, after payment of a fee.

Thus, the present application discloses systems and methods for multimedia captures with remote triggering. One embodiment of the system utilizes a multimedia unit, a wireless network, a kiosk, and the Internet to control the interactions between system users and system components. The multimedia unit is pre-positioned to record video of a user in a place of interest, and is activated by user commands in the form of SMS messages. The user can view sample pictures on a wireless device and can view high-quality pictures at a kiosk or on a home computer, by accessing a multimedia host on the Internet.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A system for capturing multimedia comprising:
a multimedia unit configured to receive a triggering signal from a wireless device via a wireless network, to capture the multimedia, and to transmit the multimedia via a system network to a multimedia host; and
the multimedia host configured to receive the multimedia via the system network and to present the multimedia to a user of the system for capturing multimedia.

2. The system of claim 1, wherein the multimedia unit is further configured to transmit the multimedia via the wireless network to the wireless device.

3. The system of claim 1, wherein the multimedia host comprises a kiosk having a built-in multimedia display.

4. The system of claim 1, wherein the multimedia host comprises an Internet server configured to download the multimedia to a client computer.

5. The system of claim 1, wherein the wireless device comprises a cell phone.

6. The system of claim 1, wherein the triggering signal is an SMS message.

7. The system of claim 1, wherein the wireless network comprises a cellular network.

8. The system of claim 1, wherein the system network comprises the Internet.

9. The system of claim 1, wherein the system network is a direct link between the multimedia unit and the multimedia host.

10. A wireless device for triggering a multimedia unit to capture multimedia comprising:
a transmitter configured to transmit a triggering signal to the multimedia unit via a wireless network;
a receiver configured to receive the multimedia from the multimedia unit via the wireless network;
an input device configured for inputting the triggering signal;
a display configured to show the multimedia;
a memory configured to store the triggering signal and the multimedia; and
a processor configured to execute a software for storing the triggering signal in the memory, providing the triggering signal from the memory to the transmitter, providing the multimedia from the receiver to the memory, and providing the multimedia from the memory to the display.

11. The system of claim 10, wherein the wireless device comprises a cell phone.

12. A method for use by a multimedia unit for capturing multimedia, the method comprising:
receiving a triggering signal from a wireless device via a wireless network, wherein the triggering signal includes an identifier for the wireless device;
capturing the multimedia; and
transmitting the multimedia according to the identifier for the wireless device to the wireless device via the wireless network.

13. The method of claim 12, further comprising transmitting the multimedia to a multimedia host via a system network.

14. The method of claim 13, wherein the multimedia host comprises a kiosk having a built-in multimedia display.

15. The method of claim 13, wherein the multimedia host comprises an Internet server configured to download the multimedia to a client computer.

16. The method of claim 12, wherein the wireless device comprises a cell phone.

17. The method of claim 12, wherein the triggering signal is an SMS message.

18. The method of claim 12, wherein the wireless network comprises a cellular network.

19. A method for use by a wireless device for capturing multimedia, the method comprising:
transmitting a triggering signal to a multimedia unit via a wireless network to request the multimedia unit to capture the multimedia, wherein the triggering signal includes an identifier for the wireless device; and
receiving the multimedia transmitted according to the identifier for the wireless device from the multimedia unit via the wireless network.

20. The method of claim 19, wherein the triggering signal is an SMS message.
